(19) United States
(12) Patent Application Publication
(10) Pub. No.: US 2025/0021300 A1
(43) Pub. Date: Jan. 16, 2025

(54) ELECTRONIC DEVICE AND METHOD OF PROCESSING USER UTTERANCE IN ELECTRONIC DEVICE

(71) Applicant: Samsung Electronics Co., Ltd., Suwon-si (KR)

(72) Inventors: Minho HONG, Suwon-si (KR); Taegu KIM, Suwon-si (KR); Saejung SHIN, Suwon-si (KR); Kyungtae KIM, Suwon-si (KR); Gajin SONG, Suwon-si (KR)

(21) Appl. No.: 18/676,939

(22) Filed: May 29, 2024

Related U.S. Application Data
(63) Continuation of application No. PCT/KR2024/006046, filed on May 3, 2024.

(30) Foreign Application Priority Data
Jul. 10, 2023 (KR) 10-2023-0089421
Aug. 7, 2023 (KR) 10-2023-0103053

(51) Int. Cl. G06F 3/16; G06F 3/01; G06F 3/0484; G06F 3/0488

(52) U.S. Cl. CPC G06F 3/167; G06F 3/013; G06F 3/0484; G06F 3/0488

(57) ABSTRACT

An example electronic device may include a display. The electronic device may include a display at least one processor. The electronic device may include a display. The electronic device may include memory for storing instructions. The instructions, when executed by the at least one processor individually or collectively, may cause the electronic device to receive an utterance of a user, obtain information on user interface (UI) components displayed on the display based on context information of the electronic device, map weights to the UI components based on the information on the UI components and gaze information of the user, determine a UI component for which a state is to be updated by the utterance among the UI components based on a weight mapping result and the utterance, and update the state of the determined UI component based on the utterance.

### CROSS-REFERENCE TO RELATED APPLICATIONS

This application is a continuation application of International Application No. PCT/KR2024/006046 designating the United States, filed on May 3, 2024, in the Korean Intellectual Property Receiving Office and claiming priority to Korean Patent Application No. 10-2023-0089421, filed on Jul. 10, 2023, and Korean Patent Application No. 10-2023-0103053, filed on Aug. 7, 2023, in the Korean Intellectual Property Office, the disclosures of which are incorporated by reference herein in their entireties.

### BACKGROUND

### 1. Field

The disclosure relates to an electronic device and a method of processing a user utterance in the electronic device.

### 2. Description of Related Art

An electronic device equipped with a voice assistant function of providing a service based on a user utterance may be provided in various ways. The electronic device may recognize an utterance of a user through an artificial intelligence (AI) server and analyze the meaning and intent of the utterance. The AI server may infer the intent of the user by interpreting the utterance of the user, and perform tasks based on the inferred intent. The AI server may perform the task according to the intent of the user represented through a natural language interaction between a user and the AI server.

The electronic device equipped with the voice assistant function may perform, in a time-series manner, an operation of classifying a domain (e.g., a capsule) (e.g., an application) for processing a user utterance and an operation of performing a task corresponding to the user utterance in the classified domain.

The above information is presented as background information only to assist with an understanding of the disclosure. No determination has been made, and no assertion is made, as to whether any of the above might be applicable as prior art with respect to the disclosure.

### SUMMARY

An electronic device according to an embodiment may include a display. The electronic may include at least one processor. The electronic may include memory for storing instructions. The instructions, when executed by the at least one processor individually or collectively, may cause the electronic device to receive an utterance of a user. The instructions, when executed by the at least one processor individually or collectively, may cause the electronic device to obtain information on user interface (UI) components displayed on the display, based on context information of the electronic device. The instructions, when executed by the at least one processor individually or collectively, may cause the electronic device to map weights to the UI components based on the information on the UI components and gaze information of the user. The instructions, when executed by the at least one processor individually or collectively, may cause the electronic device to determine a UI component for which a state is to be updated by the utterance among the UI components, based on a weight mapping result and the utterance. The instructions, when executed by the at least one processor individually or collectively, may cause the electronic device to update the state of the determined UI component based on the utterance.

A method of operating an electronic device according to an embodiment may include receiving an utterance of a user. The method may include obtaining information on UI components displayed on the display, based on context information of the electronic device. The method may include mapping weights to the UI components based on the information on the UI components and gaze information of the user. The method may include determining a UI component for which a state is to be updated by the utterance among the UI components, based on a weight mapping result and the utterance. The method may include updating the state of the determined UI component based on the utterance.

An electronic device according to an embodiment may include a display. The electronic may include at least one processor. The electronic may include memory for storing instructions. The instructions, when executed by the processor individually or collectively, may cause the electronic device to track a gaze of a user at the display. The instructions, when executed by the processor individually or collectively, may cause the electronic device to receive an utterance of the user. The instructions, when executed by the processor individually or collectively, may cause the electronic device to update a state of a UI component displayed on the display, based on the utterance.

A method of operating an electronic device according to an embodiment may include tracking a gaze of a user at the display. The method may include receiving an utterance of the user. The method may include updating a state of a UI component displayed on the display, based on the utterance.

### BRIEF DESCRIPTION OF THE DRAWINGS

The above and other aspects, features, and advantages of certain embodiments of the present disclosure will be more apparent from the following detailed description, taken in conjunction with the accompanying drawings, in which:

FIG. 1 is a block diagram illustrating an example electronic device in a network environment according to an embodiment;

FIG. 2 is a block diagram illustrating an example integrated intelligence system according to an embodiment;

FIG. 3 is a diagram illustrating an example form in which relationship information between concepts and actions is stored in a database (DB) according to an embodiment;

FIG. 4 is a diagram illustrating a screen of an example electronic device processing a received voice input through an intelligent app according to an embodiment;

FIG. 5 is a perspective view illustrating an internal configuration of an example wearable electronic device according to an embodiment;

FIGS. 6A and 6B are diagrams illustrating a front surface and a rear surface of an example wearable electronic device according to an embodiment;

FIG. 7 is a block diagram schematically illustrating an example electronic device according to an embodiment;

FIGS. 8, 9, 10, and 11 are diagrams illustrating examples of an operation of mapping a weight to a user interface (UI) component, according to an embodiment;

FIGS. 12, 13, 14, 15, 16, and 17 are diagrams illustrating examples of an operation of an example electronic device to process a user utterance according to an embodiment; and

FIGS. 18 and 19 are flowcharts illustrating example methods of operating an electronic device according to an embodiment.

### DETAILED DESCRIPTION

Hereinafter, embodiments will be described in detail with reference to the accompanying drawings. When describing the embodiments with reference to the accompanying drawings, like reference numerals refer to like components and a description related thereto may not be repeated.

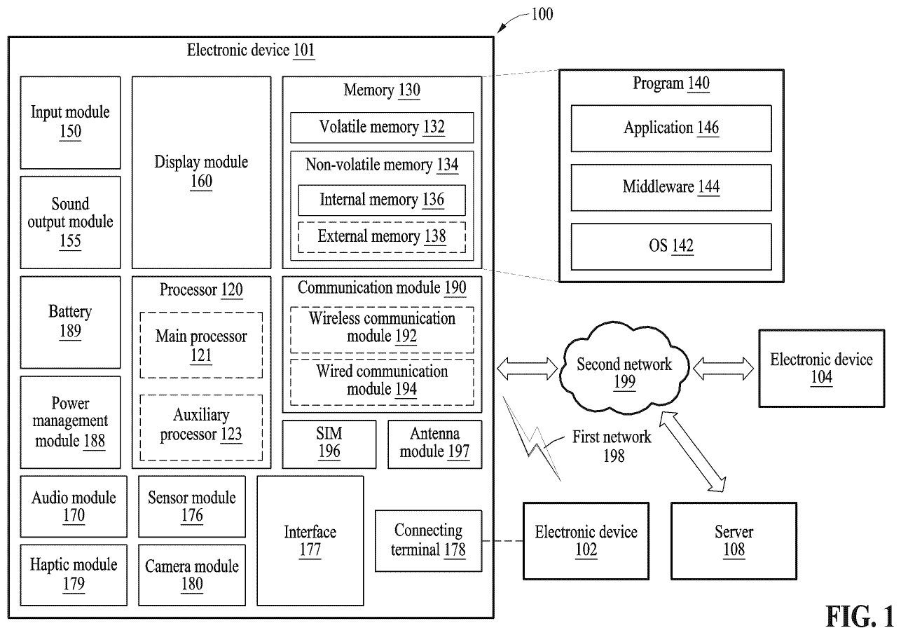

FIG. 1 is a block diagram illustrating an example electronic device 101 in a network environment 100 according to an embodiment. Referring to FIG. 1, the electronic device 101 in the network environment 100 may communicate with an electronic device 102 via a first network 198 (e.g., a short-range wireless communication network), or communicate with at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, a memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, and/or an antenna module 197. In various embodiments, at least one of the components (e.g., the connecting terminal 178) may be omitted from the electronic device 101, or one or more other components may be added in the electronic device 101. In various embodiments, some of the components (e.g., the sensor module 176, the camera module 180, or the antenna module 197) may be integrated as a single component (e.g., the display module 160).

The processor 120 according to various example embodiments of the disclosure may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions. The processor 120 may execute, for example, software (e.g., a program 140) to control at least one other component (e.g., a hardware or software component) of the electronic device 101 connected to the processor 120 and may perform various data processing or computation. According to an embodiment, as at least a part of data processing or computation, the processor 120 may store a command or data received from another component (e.g., the sensor module 176 or the communication module 190) in a volatile memory 132, process the command or the data stored in the volatile memory 132, and store resulting data in a non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121 or to be specific to a specified function. The auxiliary processor 123 may be implemented separately from the main processor 121 or as a part of the main processor 121.

The auxiliary processor 123 may control at least some of functions or states related to at least one (e.g., the display module 160, the sensor module 176, or the communication module 190) of the components of the electronic device 101, instead of the main processor 121 while the main processor 121 is in an inactive (e.g., sleep) state or along with the main processor 121 while the main processor 121 is in an active state (e.g., executing an application). According to an embodiment, the auxiliary processor 123 (e.g., an ISP or a CP) may be implemented as a portion of another component (e.g., the camera module 180 or the communication module 190) that is functionally related to the auxiliary processor 123. According to an embodiment, the auxiliary processor 123 (e.g., an NPU) may include a hardware structure specified for artificial intelligence model processing. An artificial intelligence model may be generated through machine learning. Such learning may be performed, for example, by the electronic device 101 in which an artificial intelligence model is executed, or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. An artificial neural network may include, for example, a deep neural network (DNN), a convolutional neural network (CNN), a recurrent neural network (RNN), a restricted Boltzmann machine (RBM), a deep belief network (DBN), a bidirectional recurrent deep neural network (BRDNN), a deep Q-network, or a combination of two or more thereof, but is not limited thereto. The artificial intelligence model may additionally or alternatively include a software structure other than the hardware structure.

The memory 130 may store various pieces of data used by at least one component (e.g., the processor 120 or the sensor module 176) of the electronic device 101. The various pieces of data may include, for example, software (e.g., the program 140) and input data or output data for a command related thereto. The memory 130 may include the volatile memory 132 or the non-volatile memory 134.

The program 140 may be stored as software in the memory 130 and may include, for example, an operating system (OS) 142, middleware 144, and/or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output a sound signal to the outside of the electronic device 101. The sound output module 155 may include, for example, a speaker or a receiver. The speaker may be used for general purposes, such as playing multimedia or playing a record. The receiver may be used to receive an incoming call. According to an embodiment, the receiver may be implemented as separate from, or as part of, the speaker.

The display module 160 may visually provide information to the outside (e.g., a user) of the electronic device 101. The display module 160 may include, for example, a display, a hologram device, or a projector and control circuitry to control a corresponding one of the display, the hologram device, and the projector. According to an embodiment, the display module 160 may include a touch sensor adapted to sense a touch, or a pressure sensor adapted to measure the intensity of force incurred by the touch.

The audio module 170 may convert a sound into an electrical signal or vice versa. According to an embodiment, the audio module 170 may obtain the sound via the input module 150 or output the sound via the sound output module 155 or an external electronic device (e.g., the electronic device 102 such as a speaker or headphones) directly or wirelessly connected to the electronic device 101.

The sensor module 176 may detect an operational state (e.g., power or temperature) of the electronic device 101 or an environmental state (e.g., a state of a user) external to the electronic device 101, and generate an electrical signal or data value corresponding to the detected state. According to an embodiment, the sensor module 176 may include, for example, a depth sensor, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., by wire) or wirelessly. According to an embodiment, the interface 177 may include, for example, a high-definition multimedia interface (HDMI), a universal serial bus (USB) interface, a secure digital (SD) card interface, or an audio interface.

The connecting terminal 178 may include a connector via which the electronic device 101 may be physically connected to an external electronic device (e.g., the electronic device 102). According to an embodiment, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or a movement) or an electrical stimulus which may be recognized by a user via his or her tactile sensation or kinesthetic sensation. According to an embodiment, the haptic module 179 may include, for example, a motor, a piezoelectric element, or an electric stimulator.

The camera module 180 may capture a still image and moving images. According to an embodiment, the camera module 180 may include one or more lenses, image sensors, ISPs, or flashes.

The power management module 188 may manage power supplied to the electronic device 101. According to an example, the power management module 188 may be implemented as, for example, at least a part of a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more CPs that are operable independently of the processor 120 (e.g., an AP) and that support a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module, or a power line communication (PLC) module). A corresponding one of these communication modules may communicate with the external electronic device 104 via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., a LAN or a wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the SIM 196.

The wireless communication module 192 may support a 5G network after a 4G network, and a next-generation communication technology, e.g., a new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., a mmWave band) to achieve, e.g., a high data transmission rate. The wireless communication module 192 may support various technologies for securing performance on a high-frequency band, such as, e.g., beamforming, massive multiple-input and multiple-output (MIMO), full dimensional MIMO (FD-MIMO), an array antenna, analog beam-forming, or a large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element including a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in a communication network, such as the first network 198 or the second network 199, may be selected by, for example, the communication module 190 from the plurality of antennas. The signal or power may be transmitted or received between the communication module 190 and the external electronic device via the at least one selected antenna. According to an embodiment, another component (e.g., a radio frequency integrated circuit (RFIC)) other than the radiating element may be additionally formed as a part of the antenna module 197.

According to an embodiment, the antenna module 197 may form a mmWave antenna module. According to an example, the mmWave antenna module may include a PCB, an RFIC disposed on a first surface (e.g., the bottom surface) of the PCB or adjacent to the first surface and capable of supporting a designated high-frequency band (e.g., a mmWave band), and a plurality of antennas (e.g., array antennas) disposed on a second surface (e.g., the top or a side surface) of the PCB, or adjacent to the second surface and capable of transmitting or receiving signals in the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the external electronic devices 102 or 104 may be a device of the same type as or a different type from the electronic device 101. According to an embodiment, all or some of operations to be executed at the electronic device 101 may be executed at one or more external electronic devices (e.g., the external devices 102 and 104, or the server 108). For example, if the electronic device 101 needs to perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and may transfer an outcome of the performing to the electronic device 101. The electronic device 101 may provide the outcome, with or without further processing of the outcome, as at least part of a reply to the request. To this end, cloud computing, distributed computing, mobile edge computing (MEC), or client-server computing technology may be used, for example. The electronic device 101 may provide ultra low-latency services using, e.g., distributed computing or MEC. In an embodiment, the external electronic device 104 may include an Internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

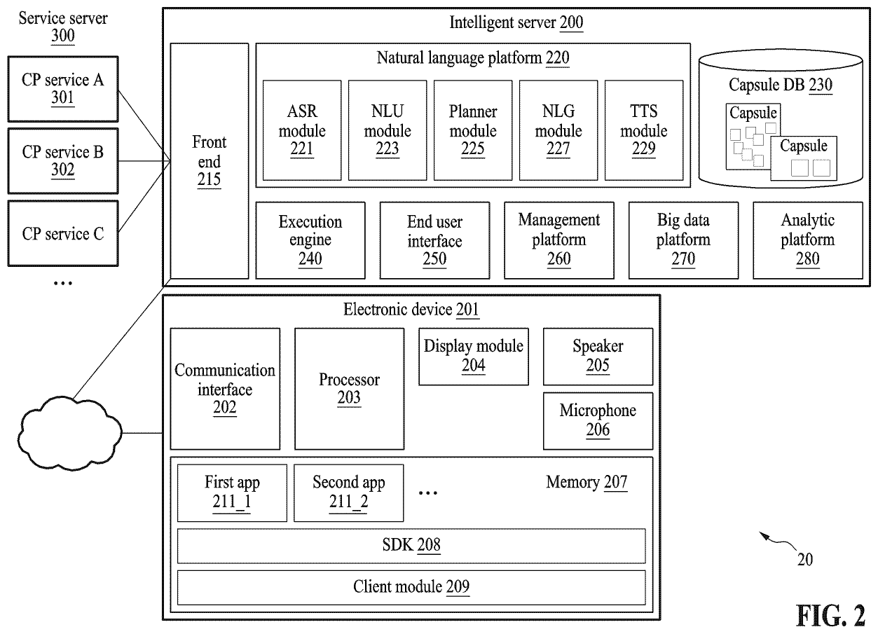

FIG. 2 is a block diagram illustrating an integrated intelligence system according to an embodiment.

Referring to FIG. 2, an example integrated intelligence system 20 according to an embodiment may include an electronic device 201 (e.g., the electronic device 101 of FIG. 1), an intelligent server 200 (e.g., the server 108 of FIG. 1), and a service server 300 (e.g., the server 108 of FIG. 1).

The electronic device 201 according to an embodiment may be a terminal device (or an electronic device) connectable to the Internet, and may be, for example, a mobile phone, a smartphone, a personal digital assistant (PDA), a notebook computer, a television (TV), a white home appliance, a wearable device, a head-mounted display (HMD), a smart speaker, or the like.

According to the illustrated embodiment, the electronic device 201 may include a communication interface 202 (e.g., the interface 177 of FIG. 1), a microphone 206 (e.g., the input module 150 of FIG. 1), a speaker 205 (e.g., the sound output module 155 of FIG. 1), a display module 204 (e.g., the display module 160 of FIG. 1), a memory 207 (e.g., the memory 130 of FIG. 1), or a processor 203 (e.g., the processor 120 of FIG. 1). The components listed above may be operationally or electrically connected to each other.

The communication interface 202 according to an embodiment may be connected to an external device and configured to transmit and receive data to and from the external device. The microphone 206 according to an embodiment may receive a sound (e.g., a user utterance) and convert the sound into an electrical signal. The speaker 205 according to an embodiment may output an electrical signal as a sound (e.g., a speech).

The display module 204 according to an embodiment may be configured to display an image or video. The display module 204 according to an embodiment may also display a graphical user interface (GUI) of an app (or an application program) being executed. The display module 204 according to an embodiment may receive a touch input through a touch sensor. For example, the display module 204 may receive a text input through a touch sensor in an on-screen keyboard area displayed in the display module 204.

The memory 207 according to an embodiment may store a client module 209, a software development kit (SDK) 208, and a plurality of apps 211. The client module 209 and the SDK 208 may configure a framework (or a solution program) for performing general-purpose functions. In addition, the client module 209 or the SDK 208 may configure a framework for processing a user input (e.g., a voice input, a text input, or a touch input).

The plurality of apps 211 stored in the memory 207 according to an embodiment may be programs for performing designated functions. According to an embodiment, the plurality of apps 211 may include a first app 211_1, a second app 211_2, and the like. According to an embodiment, each of the plurality of apps 211 may include a plurality of actions for performing a designated function. For example, the apps may include an alarm app, a messaging app, and/or a scheduling app. According to an embodiment, the plurality of apps 211 may be executed by the processor 203 to sequentially execute at least a portion of the plurality of actions.

The processor 203 according to an embodiment may control the overall operation of the electronic device 201. For example, the processor 203 may be electrically connected to the communication interface 202, the microphone 206, the speaker 205, and the display module 204 to perform a designated operation(s).

The processor 203 according to an embodiment may also perform the designated operation(s) by executing the program stored in the memory 207. For example, the processor 203 may execute at least one of the client module 209 or the SDK 208 to perform the following operation(s) for processing a user input. The processor 203 may control the actions of the plurality of apps 211 through, for example, the SDK 208. The following operation(s), which is the operation(s) of the client module 209 or the SDK 208, may be performed by the processor 203.

The client module 209 according to an embodiment may receive a user input. For example, the client module 209 may receive a voice signal corresponding to a user utterance sensed through the microphone 206. As another example, the client module 209 may receive a touch input sensed through the display module 204. As still another example, the client module 209 may receive a text input sensed through a keyboard or an on-screen keyboard. In addition, the client module 209 may receive various types of user inputs sensed through an input module included in the electronic device 201 or an input module connected to the electronic device 201. The client module 209 may transmit the received user input to the intelligent server 200. The client module 209 may transmit state information of the electronic device 201 together with the received user input to the intelligent server 200. The state information may be, for example, execution state information of an app.

The client module 209 according to an embodiment may receive a result corresponding to a received user input. For example, when the intelligent server 200 is capable of calculating a result corresponding to the received user input, the client module 209 may receive the result corresponding to the received user input. The client module 209 may display the received result on the display module 204. Further, the client module 209 may output the received result in an audio form through the speaker 205.

The client module 209 according to an embodiment may receive a plan corresponding to the received user input. The client module 209 may display results of executing a plurality of actions of an app according to the plan on the display module 204. For example, the client module 209 may sequentially display the results of executing the plurality of actions on the display module 204 and output the results in an audio form through the speaker 205. As an example, the electronic device 201 may display only a portion of the results of executing the plurality of actions (e.g., a result of the last action) on the display module 204 and output a portion of the results in an audio form through the speaker 205.

According to an embodiment, the client module 209 may receive a request for obtaining information necessary for calculating a result corresponding to the user input from the intelligent server 200. According to an embodiment, the client module 209 may transmit the necessary information to the intelligent server 200 in response to the request.

The client module 209 according to an embodiment may transmit information on the results of executing the plurality of actions according to the plan to the intelligent server 200. The intelligent server 200 may confirm that the received user input has been correctly processed using the information on the results.

The client module 209 according to an embodiment may include a speech recognition module. According to an embodiment, the client module 209 may recognize a voice input to perform a limited function through the speech recognition module. For example, the client module 209 may execute an intelligent app for processing a voice input to perform an organic operation through a designated input (e.g., Wake up!).

The intelligent server 200 according to an embodiment may receive information related to a user voice input from the electronic device 201 through a communication network. According to an embodiment, the intelligent server 200 may change data related to the received voice input to text data. According to an embodiment, the intelligent server 200 may generate a plan for performing a task corresponding to the user voice input based on the text data.

According to an embodiment, the plan may be generated by an artificial intelligence (AI) system. The AI system may be a rule-based system, or a neural network-based system (e.g., a feedforward neural network (FNN) or a recurrent neural network (RNN)). Alternatively, the AI system may be a combination of the above-described systems or other AI systems. According to an embodiment, the plan may be selected from a set of pre-defined plans or may be generated in real time in response to a user request. For example, the AI system may select at least one plan from the pre-defined plans.

The intelligent server 200 according to an embodiment may transmit a result according to the generated plan to the electronic device 201 or transmit the generated plan to the electronic device 201. According to an embodiment, the electronic device 201 may display the result according to the plan on the display module 204. According to an embodiment, the electronic device 201 may display a result of executing an action according to the plan on the display module 204.

The intelligent server 200 according to an embodiment may include a front end 215, a natural language platform 220, a capsule database (DB) 230, an execution engine 240, an end user interface 250, a management platform 260, a big data platform 270, and/or an analytic platform 280.

The front end 215 according to an embodiment may receive the received user input from the electronic device 201. The front end 215 may transmit a response corresponding to the user input.

According to an embodiment, the natural language platform 220 may include an automatic speech recognition (ASR) module 221, a natural language understanding (NLU) module 223, a planner module 225, a natural language generator (NLG) module 227, and/or a text-to-speech (TTS) module 229.

The ASR module 221 according to an embodiment may convert data related to the voice input received from the electronic device 201 into text data. The NLU module 223 according to an embodiment may determine a domain (and/or intent information) corresponding to a voice input (e.g., a user utterance) based on the text data of the voice input. The domain may correspond to a category (or a service) associated with an action (or a function) that the user intends to execute using a device. The domain may be classified based on a text-related service (e.g., an app). For example, a Gracenote domain may correspond to a music search service (e.g., a Gracenote™ service). A Melon domain may correspond to a music streaming service (e.g., Melon™ service). The domain may be associated with intent information corresponding to text. The NLU module 223 according to an embodiment may discern a user intent using the text data of the voice input. For example, the NLU module 223 may discern an intent of a user by performing syntactic analysis or semantic analysis on a user input in the form of text data. The NLU module 223 according to an embodiment may discern a meaning of a word extracted from the user input using a linguistic feature (e.g., a grammatical element) of a morpheme or a phrase, and may determine the intent of the user by matching the discerned meaning of the word to an intent. The NLU module 223 may obtain intent information corresponding to a user utterance. The intent information may be information indicating an intention of the user determined through an analysis of the text data. The intent information may include information indicating an action or function that the user intends to execute using a device. A slot may be detailed information associated with intent information. A slot may be obtained based on a domain corresponding to an utterance. A slot may be variable information needed to perform an action.

The planner module 225 according to an embodiment may generate a plan using a parameter and the intent determined by the NLU module 223. According to an embodiment, the planner module 225 may determine a plurality of domains required to perform a task based on the determined intent. The planner module 225 may determine a plurality of actions included in each of the plurality of domains determined based on the intent. According to an embodiment, the planner module 225 may determine a parameter required to execute the determined plurality of actions, or a result value output by the execution of the plurality of actions. The parameter, and the result value may be defined as a concept of a designated form (or class). Accordingly, the plan may include a plurality of actions and a plurality of concepts determined by the intent of the user. The planner module 225 may determine relationships between the plurality of actions and the plurality of concepts stepwise (or hierarchically). For example, the planner module 225 may determine an execution order of the plurality of actions determined based on the intent of the user, based on the plurality of concepts. In other words, the planner module 225 may determine the execution order of the plurality of actions based on the parameter required for the execution of the plurality of actions and results output by the execution of the plurality of actions. Accordingly, the planner module 225 may generate a plan including connection information (e.g., ontology) on connections between the plurality of actions and the plurality of concepts. The planner module 225 may generate the plan using information stored in the capsule DB 230 that stores a set of relationships between concepts and actions.

The NLG module 227 according to an embodiment may change designated information to a text form. The information changed to the text form may be in the form of a natural language utterance. The TTS module 229 according to an embodiment may change information in a text form to information in a speech form.

According to an embodiment, some or all of the functions of the natural language platform 220 may be implemented in the electronic device 201 as well.

The capsule DB 230 may store information on the relationships between the plurality of concepts and actions corresponding to the plurality of domains. A capsule according to an embodiment may include a plurality of action objects (or action information) and concept objects (or concept information) included in the plan. According to an embodiment, the capsule DB 230 may store a plurality of capsules in the form of a concept action network (CAN). According to an embodiment, the plurality of capsules may be stored in a function registry included in the capsule DB 230.

The capsule DB 230 may include a strategy registry that stores strategy information necessary for determining a plan corresponding to a voice input. The strategy information may include reference information for determining one plan when a plurality of plans corresponding to the voice input are present. According to an embodiment, the capsule DB 230 may include a follow-up registry that stores information on follow-up actions for suggesting a follow-up action to the user in a designated situation. The follow-up action may include, for example, a follow-up utterance. According to an embodiment, the capsule DB 230 may include a layout registry that stores layout information that is information output through the electronic device 201. According to an embodiment, the capsule DB 230 may include a vocabulary registry that stores vocabulary information included in capsule information. According to an embodiment, the capsule DB 230 may include a dialog registry that stores information on a dialog (or an interaction) with a user. The capsule DB 230 may update the stored objects through a developer tool. The developer tool may include, for example, a function editor for updating an action object or a concept object. The developer tool may include a vocabulary editor for updating a vocabulary. The developer tool may include a strategy editor for generating and registering a strategy for determining a plan. The developer tool may include a dialog editor for generating a dialog with a user. The developer tool may include a follow-up editor capable of activating a subsequent goal and editing a subsequent utterance that provides hints. The subsequent goal may be determined based on a currently configured goal, a preference of a user, or environmental conditions. In an embodiment, the capsule DB 230 may also be implemented in the electronic device 201.

The execution engine 240 according to an embodiment may calculate a result using the generated plan. The end user interface 250 may transmit the calculated result to the electronic device 201. Accordingly, the electronic device 201 may receive the result and provide the received result to the user. The management platform 260 according to an embodiment may manage information used in the intelligent server 200. The big data platform 270 according to an embodiment may collect data of the user. The analytic platform 280 according to an embodiment may manage a quality of service (QOS) of the intelligent server 200. For example, the analytic platform 280 may manage the components and processing rate (or efficiency) of the intelligent server 200.

The service server 300 according to an embodiment may provide a designated service (e.g., food order or hotel reservation) to the electronic device 201. According to an embodiment, the service server 300 may be a server operated by a third party. Services of the service server 300, such as a CP service A 301 and a CP service B 302, may interact with the front end 215 of the intelligent server 200. The service server 300 according to an embodiment may provide information used to generate a plan corresponding to the received user input to the intelligent server 200. The provided information may be stored in the capsule DB 230. In addition, the service server 300 may provide result information according to the plan to the intelligent server 200.

In the integrated intelligence system 20 described above, the electronic device 201 may provide various intelligent services to the user in response to a user input. The user input may include, for example, an input through a physical button, a touch input, or a voice input.

In an embodiment, the electronic device 201 may provide a speech recognition service through an intelligent app (or a speech recognition app) stored therein. In this case, for example, the electronic device 201 may recognize a user utterance or a voice input received through the microphone, and provide a service corresponding to the recognized voice input to the user.

In an embodiment, the electronic device 201 may perform a designated action alone or together with the intelligent server 200 and/or the service server 300, based on the received voice input. For example, the electronic device 201 may execute an app corresponding to the received voice input and perform a designated action through the executed app.

In an embodiment, when the electronic device 201 provides a service together with the intelligent server 200 and/or the service server 300, the electronic device 201 may detect a user utterance using the microphone 206 and generate a signal (or voice data) corresponding to the detected user utterance. The electronic device 201 may transmit the voice data to the intelligent server 200 using the communication interface 202.

The intelligent server 200 according to an embodiment may generate, as a response to the voice input received from the electronic device 201, a plan for performing a task corresponding to the voice input or a result of performing an action according to the plan. The plan may include, for example, a plurality of actions for performing a task corresponding to a voice input of a user, and a plurality of concepts related to the plurality of actions. The concepts may be defined as parameters that are input for execution of the plurality of actions or result values that are output by execution of the plurality of actions. The plan may include connection information on connections between the plurality of actions and the plurality of concepts.

The electronic device 201 according to an embodiment may receive the response using the communication interface 202. The electronic device 201 may output a voice signal generated inside the electronic device 201 to the outside using the speaker 205, or may output an image generated inside the electronic device 201 to the outside using the display module 204.

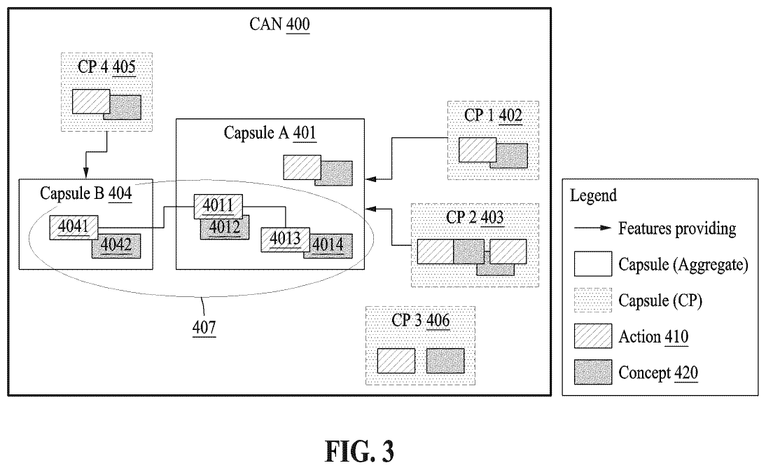

FIG. 3 is a diagram illustrating an example form in which relationship information on relationships between concepts and actions is stored in a DB according to an embodiment.

A capsule DB (e.g., the capsule DB 230 of FIG. 2) of an intelligent server (e.g., the intelligent server 200 of FIG. 2) may store capsules in the form of a CAN 400. The capsule DB may store an action for processing a task corresponding to a voice input of a user and a parameter necessary for the action in the form of a CAN.

The capsule DB may store a plurality of capsules (a capsule A 401 and a capsule B 404) respectively corresponding to a plurality of domains. According to an embodiment, one capsule (e.g., the capsule A 401) may correspond to one domain (e.g., a location (geo) or an application). In addition, the one capsule may correspond to at least one service provider (e.g., CP 1 402 or CP 2 403) for performing a function for a domain related to the capsule. According to an embodiment, one capsule may include at least one action 410 and at least one concept 420 to perform a designated function. The CAN 400 may store other information, for example, CP 3 406. In addition, the capsule B 404 may correspond to a service provider (e.g., CP 4 405).

A natural language platform (e.g., the natural language platform 220 of FIG. 2) may generate a plan for performing a task corresponding to the received voice input using the capsules stored in the capsule DB. For example, a planner module (e.g., the planner module 225 of FIG. 2) of the natural language platform may generate a plan using the capsules stored in the capsule DB. For example, a plan 407 may be generated using actions 4011 and 4013 and concepts 4012 and 4014 of the capsule A 401 and an action 4041 and a concept 4042 of the capsule B 404.

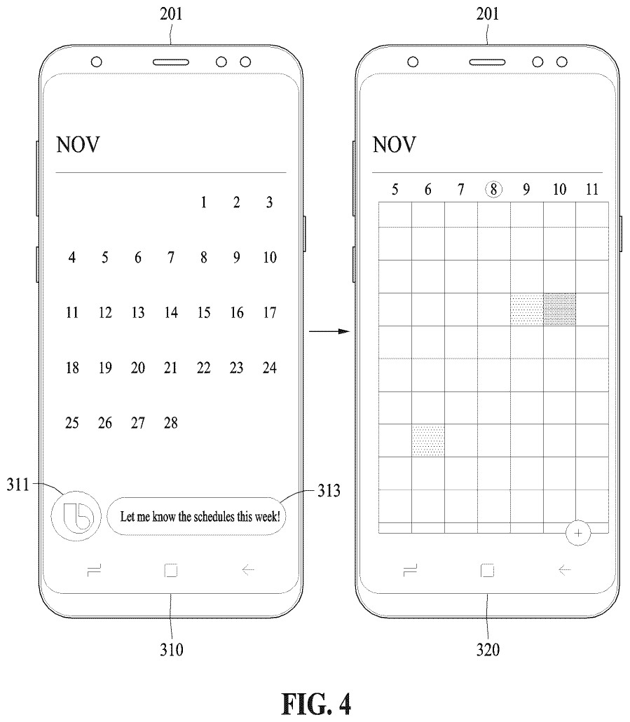

FIG. 4 is a diagram illustrating a screen of an example electronic device processing a received voice input through an intelligent app according to an embodiment.

An electronic device 201 may execute an intelligent app to process a user input through an intelligent server (e.g., the intelligent server 200 of FIG. 2).

According to an embodiment, on a screen 310, when a designated voice input (e.g., Wake up!) is recognized or an input through a hardware key (e.g., a dedicated hardware key) is received, the electronic device 201 may execute an intelligent app for processing the voice input. The electronic device 201 may execute the intelligent app, for example, in a state in which a scheduling app is executed. According to an embodiment, the electronic device 201 may display an object (e.g., an icon) 311 corresponding to the intelligent app on the display module (e.g., the display module 160 of FIG. 1 or the display module 204 of FIG. 2). According to an embodiment, the electronic device 201 may receive a voice input by a user utterance. For example, the electronic device 201 may receive a voice input of “Let me know the schedules this week!”. According to an embodiment, the electronic device 201 may display a user interface (UI) 313 (e.g., an input window) of the intelligent app in which text data of the received voice input is displayed on the display module 204.

According to an embodiment, on a screen 320, the electronic device 201 may display a result corresponding to the received voice input on the display module 204. For example, the electronic device 201 may receive a plan corresponding to the received user input, and display “the schedules this week” on the display module 204 according to the plan.

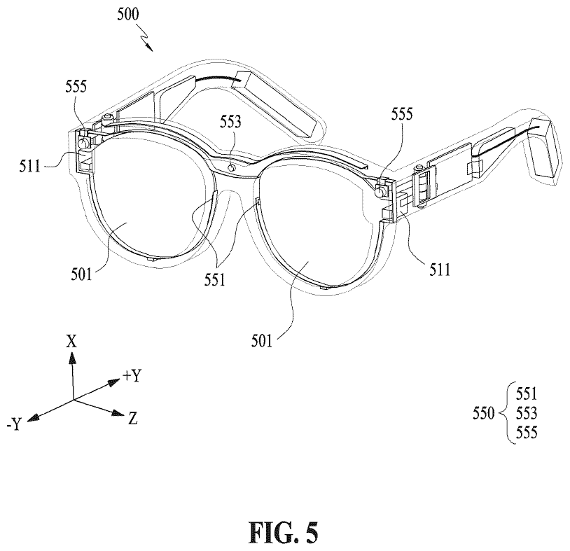

FIG. 5 is a perspective view illustrating an internal configuration of an example wearable electronic device according to an embodiment.

Referring to FIG. 5, a wearable electronic device 500 according to an embodiment may include at least one of a light output module 511, a display member 501, and a camera module 550. The wearable electronic device 500 (e.g., the electronic device 102 of FIG. 1) may be implemented separately from an electronic device (e.g., the electronic device 101 of FIG. 1 or the electronic device 201 of FIG. 2). The wearable electronic device 500 (e.g., the electronic device 102 of FIG. 1) may be connected to the electronic device (e.g., the electronic device 101 of FIG. 1 or the electronic device 201 of FIG. 2).

According to an embodiment, the light output module 511 may include a light source to output an image, and a lens to guide an image to the display member 501. According to an embodiment of the present disclosure, the light output module 511 may include at least one of a liquid crystal display (LCD), a digital micromirror device (DMD), or a liquid crystal on silicon (LCoS), an organic light-emitting diode (OLED), or a micro light-emitting diode (micro LED).

According to an embodiment, the display member 501 may include an optical waveguide (e.g., a waveguide). According to an embodiment of the disclosure, an image output by the light output module 511 and incident to one end of the optical waveguide may be propagated inside the optical waveguide and provided to a user. According to an embodiment of the present disclosure, the optical waveguide may include at least one of at least one diffractive element (e.g., a diffractive optical element (DOE), or a holographic optical element (HOE)) or a reflective element (e.g., a reflective mirror). For example, the optical waveguide may guide the image output by the light output module 511 to eyes of the user, using the at least one diffractive element or the reflective element.

According to an embodiment, the camera module 550 may capture a still image and/or moving images. According to an embodiment, the camera module 550 may be disposed within a lens frame and disposed around the display member 501. The camera module 550 may include a first camera module 551, a second camera module 553, and a third camera module 555.

According to an embodiment, the first camera module 551 may capture and/or recognize a trajectory of a gaze or eye (e.g., a pupil or an iris) of the user. According to an embodiment of the present disclosure, the first camera module 551 may periodically or aperiodically transmit information (e.g., trajectory information) associated with the trajectory of the gaze or eye of the user to a processor (e.g., the processor 120 of FIG. 1). According to an embodiment, the second camera module 553 may capture an external image.

According to an embodiment, the third camera module 555 may be used for hand detection and tracking and for recognition of a gesture (e.g., a hand gesture) of the user. The third camera module 555 according to an embodiment of the present disclosure may be used for three degrees of freedom (3DoF) and six degrees of freedom (6DoF) head tracking, recognition of a position (space and environment), and/or recognition of a movement. The second camera module 553 according to an embodiment of the present disclosure may also be used for hand detection and tracking and recognition of a gesture of the user. According to an embodiment of the present disclosure, at least one of the first camera module 551, the second camera module 553, or the third camera module 555 may be replaced by a sensor module (e.g., a light detection and ranging (LiDAR) sensor). For example, the sensor module may include at least one of a vertical-cavity surface-emitting laser (VCSEL), an infrared sensor, and/or a photodiode.

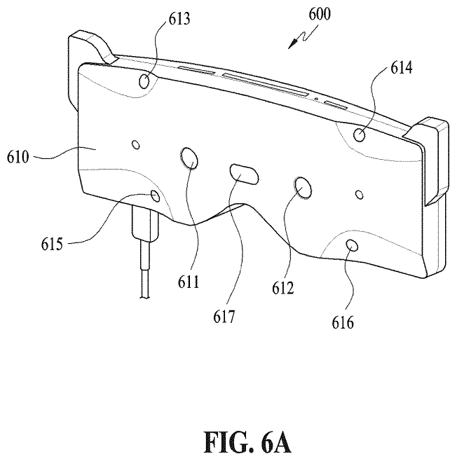

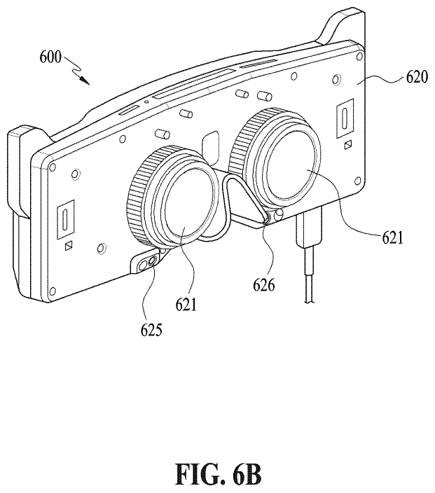

FIGS. 6A and 6B are diagrams illustrating a front surface and a rear surface of an example wearable electronic device 600 according to an embodiment.

Referring to FIGS. 6A and 6B, according to an embodiment, an electronic device (e.g., the electronic device 101 of FIG. 1 or the electronic device 201 of FIG. 2) may be implemented in the form of the wearable electronic device 600. On a first surface 610 of a housing, camera modules 611, 612, 613, 614, 615, and 616 (e.g., the camera module 180 of FIG. 1) and/or a depth sensor 617 (e.g., the sensor module 176 of FIG. 1) to obtain information associated with a surrounding environment of the wearable electronic device 600 may be arranged.

According to an embodiment, the camera modules 611 and 612 may obtain an image related to the surrounding environment of the wearable electronic device 600.

According to an embodiment, the camera modules 613, 614, 615, and 616 may obtain an image in a state in which the wearable electronic device 600 is worn by a user. The camera modules 613, 614, 615, and 616 may be used for hand detection and tracking and recognition of a gesture (e.g., a hand gesture) of a user. The camera modules 613, 614, 615, and 616 may be used for 3DoF and 6DoF head tracking, recognition of a position (space and environment), and/or recognition of a movement. According to an embodiment, the camera modules 611 and 612 may also be used for hand detection and tracking and recognition of a gesture of the user.

According to an embodiment, the depth sensor 617 may be configured to transmit a signal and receive a signal reflected from an object and may be used to identify a distance to the object, for example, using time of flight (TOF). The camera modules 613, 614, 615, and 616, instead of or in addition to the depth sensor 617, may identify the distance to the object.

According to an embodiment, on a second surface 620 of the housing, camera modules 625 and 626 (e.g., the camera module 180 of FIG. 1) for face recognition, and/or a display 621 (e.g., the display module 160 of FIG. 1 or the display module 204) of FIG. 2) (and/or a lens) may be disposed.

According to an embodiment, the camera modules 625 and 626 for face recognition adjacent to a display may be used to recognize a face of a user or to track eyes of the user.

According to an embodiment, the display 621 (and/or the lens) may be disposed on the second surface 620 of the wearable electronic device 600. According to an embodiment, the wearable electronic device 600 may not include the camera modules 615 and 616 among the plurality of camera modules 613, 614, 615, and 616. Although not shown in FIGS. 6A and 6B, the wearable electronic device 600 may further include at least one configuration among the configurations shown in FIG. 5.

As described above, the wearable electronic device 600 according to an embodiment may have a form factor to be worn on a head of a user. The wearable electronic device 600 may further include a wearing member and/or a strap to be fixed onto a body part of the user. The wearable electronic device 600 in a state of being worn on the head of the user may provide a user experience based on an augmented reality (AR), a virtual reality (VR), and/or a mixed reality (MR).

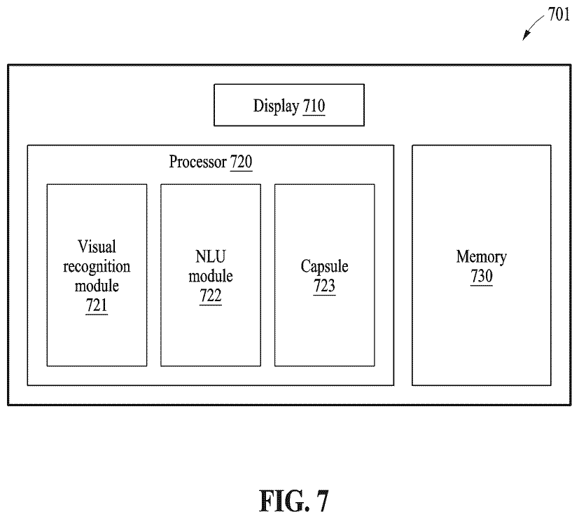

FIG. 7 is a block diagram schematically illustrating an example electronic device according to an embodiment.

Referring to FIG. 7, according to an embodiment, an electronic device 701 may include at least a portion of configurations of the electronic device 101 described above with reference to FIG. 1 and the electronic device 201 described above with reference to FIG. 2. An on-device AI for processing an utterance without communication with an intelligent server (e.g., the intelligent server 200 of FIG. 2) may be installed in the electronic device 701. Components, such as the natural language platform 220 described above with reference to FIGS. 2 to 4, may be implemented in the electronic device 701. With respect to the electronic device 701, descriptions provided with reference to FIGS. 1 to 4 are not repeated here.

According to an embodiment, the electronic device 701 may be connected to smart glasses including a wearable electronic device (e.g., the wearable electronic device 500 of FIG. 5) (e.g., VR glasses). In an embodiment, the electronic device 701 may be implemented as a separate device from the wearable electronic device, however, embodiments are not limited thereto. In other words, the electronic device 701 may be implemented in the form of a wearable electronic device (e.g., the wearable electronic device 600 of FIG. 6) (e.g., an HMD including an AR device, a VR device, and an MR device). The electronic device 701 may be configured to easily control UI components provided in an AR environment and a VR environment.

According to an embodiment, the electronic device 701 may control a UI component (e.g., update a state of a UI component, and input data to a UI component), using a voice interface (e.g., based on a voice assistant). The electronic device 701 may utilize a configuration of a UI component displayed by the electronic device 701 as context of the electronic device 701. The electronic device 701 may map a weight to a UI component and specify a UI component that a user desires to control among a plurality of UI components. The electronic device 701 may easily control a UI component displayed by the electronic device 701, based on context, a user utterance, and/or a gaze of a user.

According to an embodiment, the electronic device 701 may include a display 710 (e.g., the display module 160 of FIG. 1, and the display module 204 of FIG. 2), a processor 720 (e.g., the processor 120 of FIG. 1, and the processor 203 of FIG. 2), and a memory 730 (e.g., the memory 130 of FIG. 1, and the memory 207 of FIG. 2). The memory 730 may store a variety of data used by at least one component (e.g., the processor 720) of the electronic device 701.

According to an embodiment, the display 710 may visually provide information to the outside (e.g., a user) of the electronic device 701. The display 710 may be configured to display an image or video. The display 710 may also display a GUI of an app (or an application program) being executed. The display 710 may include, for example, a display, a hologram device, or a projector and control circuitry to control a corresponding one of the display, the hologram device, and the projector. For example, the display 710 may include a touch sensor adapted to sense a touch, or a pressure sensor adapted to measure an intensity of a force incurred by the touch.

According to an embodiment, the processor 720 (e.g., an application processor) may execute instructions by accessing the memory 730. The processor 720 may perform cause the electronic device 701 to provide a response to a user. The processor 720 may include a visual recognition module 721, an NLU module 722, and a capsule 723.

According to an embodiment, the visual recognition module 721 may obtain gaze information of a user. The visual recognition module 721 may be configured to obtain gaze information based on information (e.g., information associated with a trajectory of a gaze or eye of a user) that is obtained by the electronic device 701 implemented separately from the wearable electronic device (e.g., the wearable electronic device 500 of FIG. 5) from the wearable electronic device. The visual recognition module 721 may be configured to obtain gaze information based on a result of tracking eyes of the user by the electronic device 701 implemented in the form of the wearable electronic device (e.g., the wearable electronic device 600 of FIG. 6).

According to an embodiment, the NLU module 722 may perform at least a portion of operations of the NLU module 223 described above with reference to FIG. 2. The NLU module 722 may receive text data corresponding to a user utterance. The NLU module 722 may obtain information on UI components displayed on the display 710, based on context information of the electronic device 701. The context information of the electronic device 701 may include information on an application being executed on the electronic device 701 at a point in time at which a user utterance is received. The information on the UI components may include position information of the UI components displayed on the display 710.

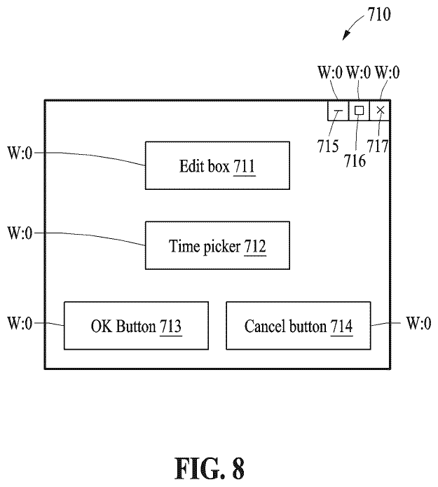

According to an embodiment, the NLU module 722 may map weights to UI components, based on the information on the UI components and the gaze information of the user. The gaze information may correspond to a focus of the user gazing at an arbitrary point on the display 710. As described above, the gaze information may be obtained using the visual recognition module 721. An operation of mapping weights will be described in detail with reference to FIGS. 8 to 11.

According to an embodiment, the NLU module 722 may determine a UI component for which a state is to be updated by a user utterance (e.g., text data corresponding to a user utterance) among the UI components, based on a weight mapping result and the user utterance. The NLU module 722 may identify supportable utterances for each UI component. The NLU module 722 may be trained based on training data shown in Table 1 and Table 2 below.

TABLE 1

| | | Example |
|---|---|---|
| UI component | Item | Supportable utterance(s) |
| App bar | Resize App | Bigger, Smaller |
| App bar | Close (single/multiple) | Close, Close all app |
| | App | |
| App bar | Grab App | Grab |
| App bar | Stop to Grab App | Release |
| App bar | Move App | Move |
| App bar | Minimize App | Minimize |
| App bar | Push App | Push |
| App bar | Pull App | Pull |
| Text field | Dictation | (auto-start) |
| Time-picker | Set Time | 6:30 a.m. |
| Date-picker | Set Date | Tomorrow |
| Date and Time | Set Date and Time | 10 AM tomorrow |
| picker | | |
| Button | Select Button | Select |
| Checkbox | Check Checkbox | Check |
| Radio button | Check Radio Button | Check this one |
| Switch | Switch On | Turn on the |
| | | {switch label name} |
| Switch | Switch Off | Turn this off |
| Scroll bar etc. | Scroll up | Scroll up |
| Scroll bar etc. | Scroll down | Scroll down |
| Image View etc. | Zoom in | Zoom in |
| Image View etc. | Zoom out | Zoom out |
| Listview, Single | Navigation on List | go up/down, next/previous |
| Choice Dialog | | |
| Listview | Select on List | Select, Ordinal Select |
| | | (The second one) |
| Slider | Set Value | {number} percent |
| Slider | Increase Value | Increase {number} percent |
| Slider | Decrease Value | Decrease {number} percent |
| Snack bar | Select among available | Share, Edit |
| | actions | |

Referring to Table 1, items (e.g., supportable actions) and example supportable utterances for each UI component may be identified. For example, a time-picker may support a set time action. An example supportable utterance for setting a time of the time picker may correspond to a time (e.g., 6:30 a.m.) a user desires to set.

TABLE 2

| | | Example Supportable |
|---|---|---|
| Widget | Item | utterance |
| 2D/3D Widget | Resize Widget | Bigger, Smaller |
| 2D/3D Widget | Grab Widget | Grab |
| 2D/3D Widget | Stop to Grab Widget | Release |
| 2D/3D Widget | Move Widget | Move |
| 2D/3D Widget | Refresh Widget | Refresh |
| 2D/3D Widget | Delete Widget | Delete |
| 2D/3D Widget | Send Widget to other Space | Send it to {Space name} |
| 3D Widget | Rotate Widget | Rotate |

Referring to Table 2, items (e.g., support actions) and example supportable utterances of widgets may be identified. The widgets may be based on UI components. The widgets may be divided into a two-dimensional (2D) widget and a three-dimensional (3D) widget. For example, a supportable utterance for a rotation of a 3D widget (e.g., rotate widget) may correspond to “rotate.”

According to an embodiment, the capsule 723 (e.g., an application) may update a state of a UI component (e.g., a UI component that is determined by the NLU module 722 and of which state is to be updated by a user utterance). The capsule 723 may be stored in the form of the capsule DB 230 of FIG. 2. Although only one capsule (e.g., the capsule 723) corresponding to an utterance is shown in FIG. 7, it should be noted that a set of capsules may be stored in the capsule DB 230.

According to an embodiment, the electronic device 701 may map a weight to a UI component and specify a UI component that a user desires to control among a plurality of UI components. Hereinafter, a weight mapping operation is described in detail.

FIGS. 8, 9, 10, and 11 are diagrams illustrating example operations of mapping a weight to a UI component, according to an embodiment.

Referring to FIG. 8, according to an embodiment, UI components 711, 712, 713, 714, 715, 716, and 717 displayed on the display 710 (e.g., the display module 160 of FIG. 1, and the display module 204 of FIG. 2) of the electronic device 701 (e.g., the electronic device 101 of FIG. 1, and the electronic device 201 of FIG. 2) may be identified. Weights may not yet be mapped to UI components (e.g., in a state in which a weight of “O” is mapped).

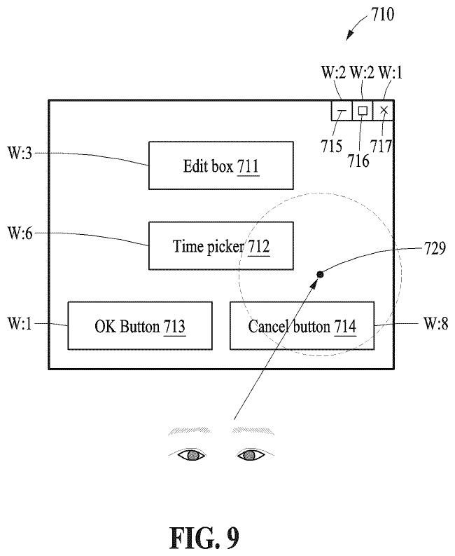

Referring to FIG. 9, according to an embodiment, the electronic device 701 may set a weight based on a distance between a focus 729 (e.g., a focus of a user gazing at an arbitrary point on the display 710) and a UI component (e.g., the UI components 711 to 717). The electronic device 701 may map weights to the UI components 711 to 717 such that the weights may be inversely proportional to the distance between the focus 729 and the UI component (e.g., the UI components 711 to 717). For example, a highest weight, e.g., a weight of “8,” may be mapped (or set) to a UI component (e.g., a UI component cancel button 714) closest to the focus 729. For example, a lowest weight, e.g., a weight of “1,” may be mapped (or set) to a UI component (e.g., a UI component ok button 713) farthest from the focus 729. The distance between the focus 729 and the UI component may be calculated based on a distance between a central point of the UI component and a focus. However, it should be noted that if an area of a UI component is relatively large, the area of the UI component may be taken into consideration in setting of a weight.

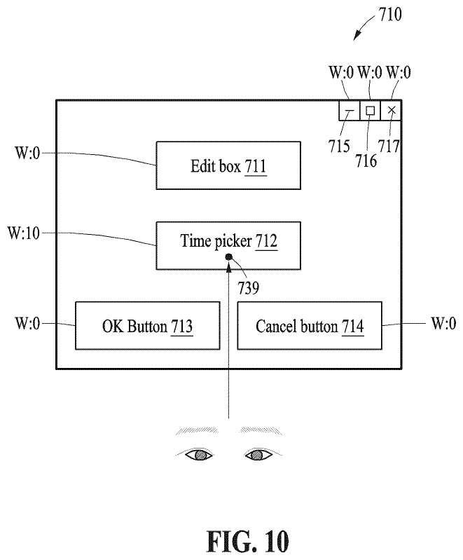

Referring to FIG. 10, according to an embodiment, when a focus 739 corresponds to an arbitrary UI component (e.g., a UI component time picker 712), the electronic device 701 may map a weight of “0” to UI components (e.g., the UI components 711 and 713 to 717) other than the arbitrary UI component. A case in which the focus 739 corresponds to the arbitrary UI component may refer to, for example, a case in which the focus 739 is inside the arbitrary UI component.

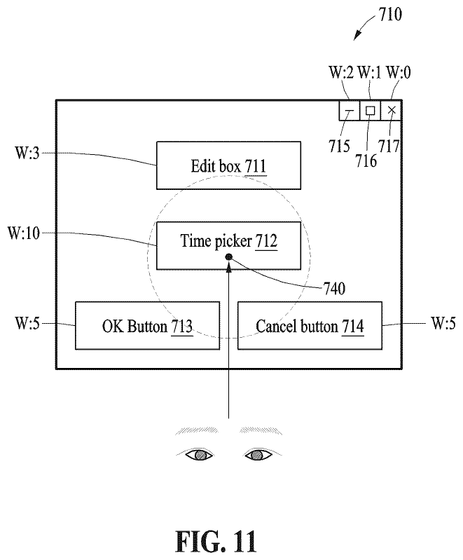

Referring to FIG. 11, according to an embodiment, the electronic device 701 may map weights other than “0” to UI components (e.g., the UI components 711 and 713 to 717) other than an arbitrary UI component (e.g., a UI component time picker 712), even when a focus 740 corresponds to the arbitrary UI component. The electronic device 701 may map weights to the UI components (e.g., the UI components 711 and 713 to 717) such that the weights may be inversely proportional to a distance between the focus 740 and the UI components (e.g., the UI components 711 and 713 to 717).

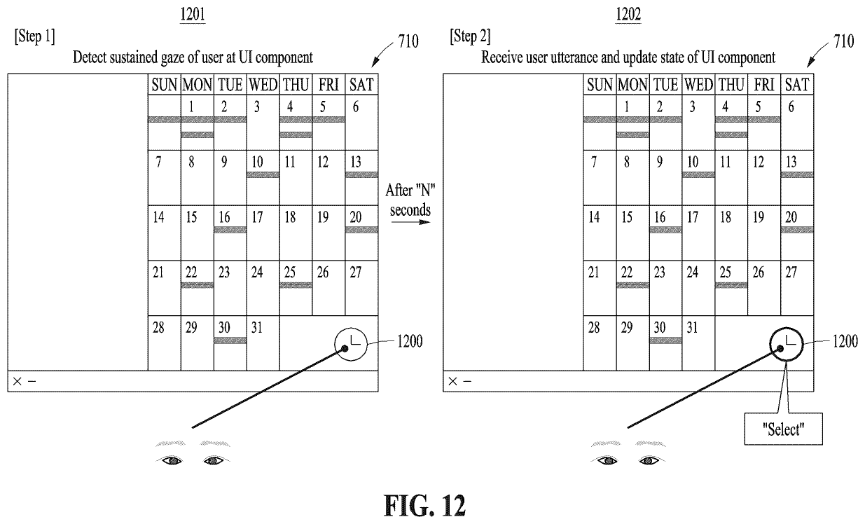

FIGS. 12, 13, 14, 15, 16, and 17 are diagrams illustrating example operations of an example electronic device to process a user utterance according to an embodiment.

Referring to FIG. 12, according to an embodiment, in a situation 1201, the electronic device 701 (e.g., the electronic device 101 of FIG. 1, and the electronic device 201 of FIG. 2) may detect a sustained gaze of a user (e.g., a sustained gaze for “N” seconds) at a UI component 1200. The electronic device 701 may activate a voice assistant function (e.g., activate an operation of the intelligent server 200 described above with reference to FIG. 2) in response to the detected sustained gaze.

According to an embodiment, in a situation 1202, the electronic device 701 with the activated voice assistant function may receive an utterance of the user and update (e.g., activate) a state of the UI component 1200. The updated UI component 1200 may be selected by a user gaze and a user utterance. In other words, the operation of the electronic device 701 described above with reference to FIGS. 8 to 12 may be triggered when a sustained gaze of the user at one (e.g., the UI component 1200) of UI components is detected.

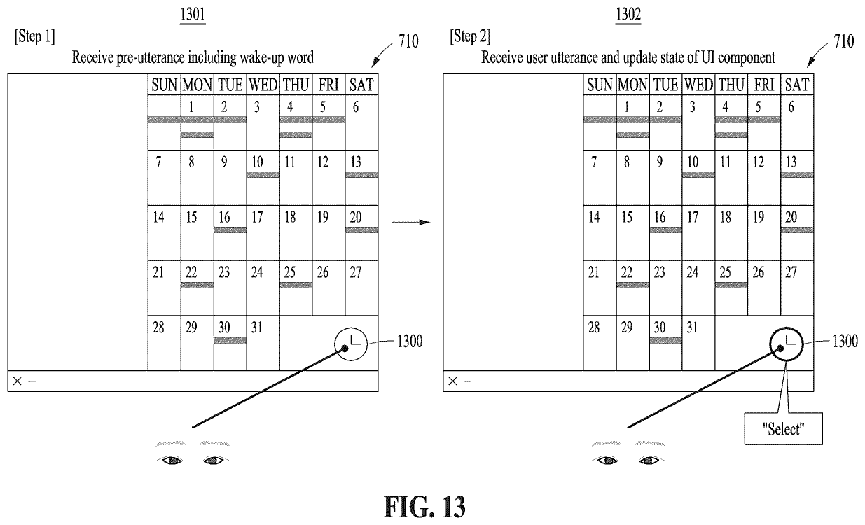

Referring to FIG. 13, according to an embodiment, in a situation 1301, the electronic device 701 (e.g., the electronic device 101 of FIG. 1, and the electronic device 201 of FIG. 2) may receive a pre-utterance including a wake-up word. The wake-up word may be a word (or a phrase, and a sentence) used to activate the voice assistant function (e.g., activate the operation of the intelligent server 200 described above with reference to FIG. 2). The electronic device 701 may activate the voice assistant function, in respond to the pre-utterance including the wake-up word.

According to an embodiment, in a situation 1302, the electronic device 701 with the activated voice assistant function may receive an utterance of the user and update (e.g., activate) a state of a UI component 1300. The updated UI component 1300 may be selected by the utterance of the user. In other words, the operation of the electronic device 701 described above with reference to FIGS. 8 to 12 may be triggered when an utterance including the wake-up word is received.

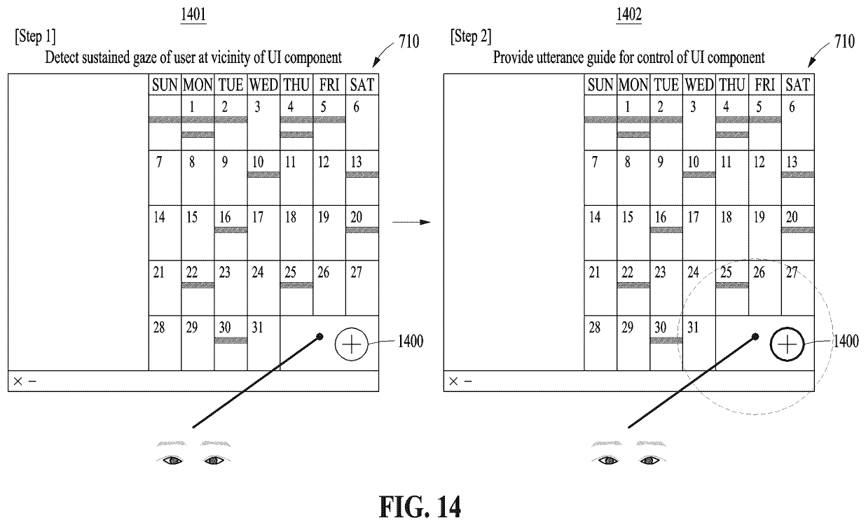

Referring to FIG. 14, according to an embodiment, in a situation 1401, the electronic device 701 (e.g., the electronic device 101 of FIG. 1, and the electronic device 201 of FIG. 2) may detect a sustained gaze of a user (e.g., a sustained gaze for “N” seconds) at the vicinity of a UI component 1400.

According to an embodiment, in a situation 1402, the electronic device 701 may provide an utterance guide (e.g., “Try speaking ‘Add a schedule on what date and month,’ if you want to add to the schedule.”) for a control of the UI component 1400.

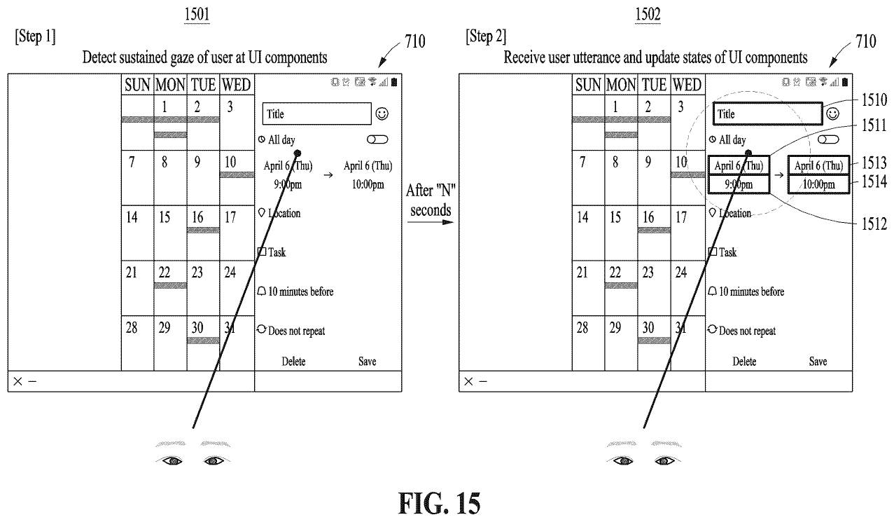

Referring to FIG. 15, in a situation 1501, the electronic device 701 (e.g., the electronic device 101 of FIG. 1, and the electronic device 201 of FIG. 2) may detect a sustained gaze of a user (e.g., a sustained gaze for “N” seconds) at UI components. The electronic device 701 may activate a voice assistant function (e.g., activate the operation of the intelligent server 200 described above with reference to FIG. 2) in response to the detected sustained gaze.

According to an embodiment, in a situation 1502, the electronic device 701 with the activated voice assistant function may receive an utterance of the user and update states of UI components 1510, 1511, 1512, 1513, and 1514. As in situation 1502, if the user utters “Add a schedule Z from 9:00 pm, April 6 to 10:00 pm, April 6,” a state of the UI component 1510 corresponding to the “schedule Z” may be updated, a state of the UI component 1511 corresponding to “April 6” may be updated, a state of the UI component 1512 corresponding to “9:00 pm” may be updated, a state of the UI component 1513 corresponding to “April 6” may be updated, and a state of the UI component 1514 corresponding to “10:00 pm” may be updated. In other words, the number of UI components of which states are to be updated by a user utterance is not be limited to one.

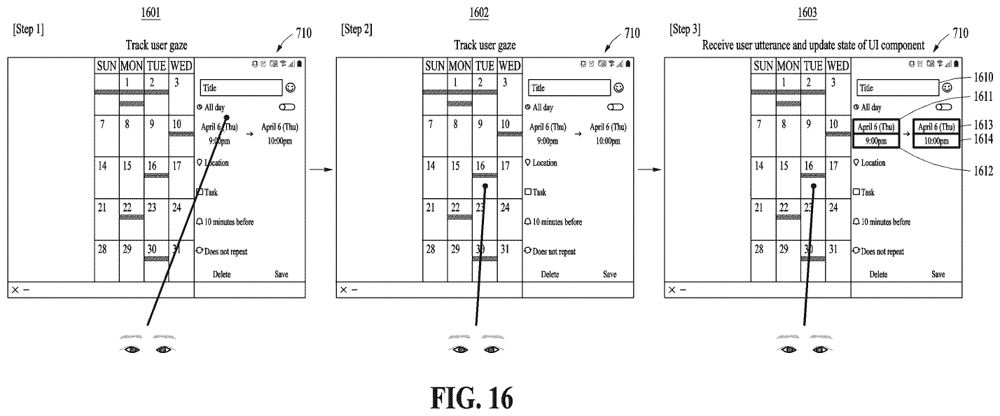

Referring to FIG. 16, according to an embodiment, in a situation 1601, the electronic device 701 (e.g., the electronic device 101 of FIG. 1, and the electronic device 201 of FIG. 2) may track a gaze of a user at the display 710 (e.g., the display module 160 of FIG. 1, and the display module 204 of FIG. 2). In situation 1602, the electronic device 701 may continue to track the gaze of the user, and a component that the user gazes in situation 1602 may be different from a component that the user gazes in situation 1601. In situation 1603, the electronic device 701 may receive an utterance of the user and update states of UI components 1610, 1611, 1612, 1613, and 1614. A UI component (e.g., the UI components 1610 to 1614) for which a state is to be updated may be a UI component that the user gazes (e.g., the situation 1601) before a point in time at which the utterance was received (e.g., the situation 1603).

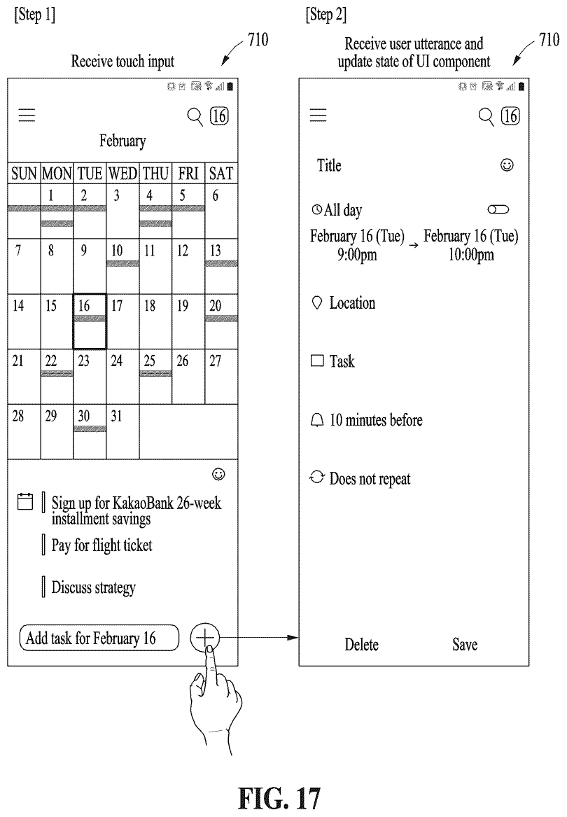

Referring to FIG. 17, the electronic device 701 (e.g., the electronic device 101 of FIG. 1, and the electronic device 201 of FIG. 2) may receive a touch input of a user to the display 710 (e.g., the display module 160 of FIG. 1, and the display module 204 of FIG. 2). The electronic device 701 may activate the voice assistant function (e.g., activate the operation of the intelligent server 200 described above with reference to FIG. 2), in response to the received touch input. According to an embodiment, the electronic device 701 with the activated voice assistant function may receive an utterance of the user and update a state of a UI component.

According to an embodiment, the electronic device 701 may control a UI component (e.g., update a state of a UI component, and input data to a UI component), using a voice interface (e.g., based on a voice assistant). The electronic device 701 may utilize a configuration of a UI component displayed by the electronic device 701 as context of the electronic device 701. Th electronic device 701 may control a UI component displayed by the electronic device 701 based on context, a user utterance, and/or a user gaze.

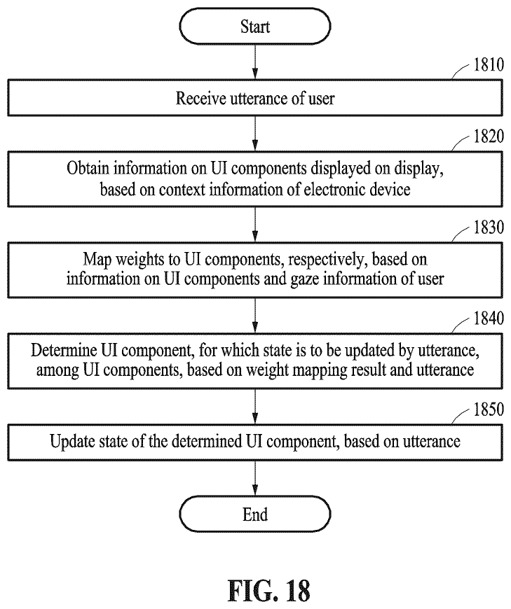

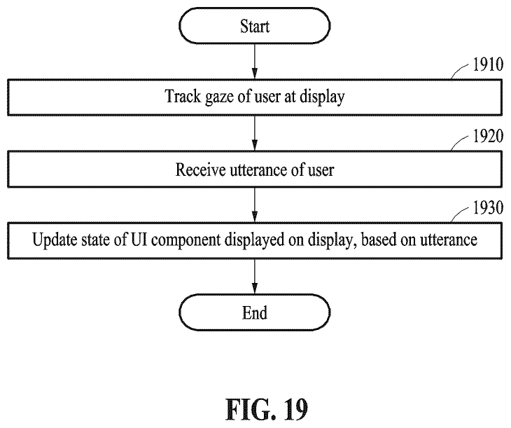

FIGS. 18 and 19 are flowcharts illustrating example methods of operating an electronic device according to an embodiment.

Referring to FIG. 18, operations 1810, 1820, 1830, 1840, and 1850 may be performed sequentially, but are not necessarily performed sequentially. For example, the order of operations 1810 through 1850 may be changed, and/or at least two of operations 1810 through 1850 may be performed in parallel. According to an embodiment, operations 1810 through 1850 may be performed by a processor(s) (e.g., the processor 120 of FIG. 1, and the processor 203 of FIG. 2) of an electronic device (e.g., the electronic device 101 of FIG. 1, the electronic device 201 of FIG. 2, and the electronic device 701 of FIG. 7).

In operation 1810, the electronic device (e.g., the electronic device 101 of FIG. 1, the electronic device 201 of FIG. 2, and the electronic device 701 of FIG. 7) according to an embodiment may receive an utterance of a user.

In operation 1820, the electronic device 701 according to an embodiment may obtain information on UI components displayed on a display (e.g., the display module 160 of FIG. 1, the display 204 of FIG. 2, and the display 710 of FIG. 7) based on context information of the electronic device 701.

In operation 1830, the electronic device 701 according to an embodiment may map weights to the UI components, respectively, based on the information on the UI components and gaze information of the user.

In operation 1840, the electronic device 701 according to an embodiment may determine a UI component for which a state is to be updated by the utterance among the UI components, based on a weight mapping result and the utterance.

In operation 1850, the electronic device 701 according to an embodiment may update the state of the determined UI component based on the utterance.

Referring to FIG. 19, operations 1910, 1920, and 1930 may be performed sequentially, but are not necessarily performed sequentially. For example, the order of operations 1910 through 1930 may be changed, and/or at least two of operations 1910 through 1930 may be performed in parallel. According to an embodiment, operations 1910 through 1930 may be performed by a processor (e.g., the processor 120 of FIG. 1, and the processor 203 of FIG. 2) of an electronic device (e.g., the electronic device 101 of FIG. 1, the electronic device 201 of FIG. 2, and the electronic device 701 of FIG. 7).

In operation 1910, the electronic device (e.g., the electronic device 101 of FIG. 1, the electronic device 201 of FIG. 2, and the electronic device 701 of FIG. 7) according to an embodiment may track a gaze of a user at a display (e.g., the display module 160 of FIG. 1, the display 204 of FIG. 2, and the display 710 of FIG. 7).

In operation 1920, the electronic device 701 according to an embodiment may receive an utterance of the user.

In operation 1930, the electronic device 701 according to an embodiment may update a state of a UI component displayed on the display, based on the utterance. A UI component for which a state is updated may be a UI component that the user gazes before a point in time at which the utterance is received.

An electronic device (e.g., the electronic device 101 of FIG. 1, the electronic device 201 of FIG. 2, and the electronic device 701 of FIG. 7) according to an embodiment may include a display (e.g., the display module 160 of FIG. 1, the display module of 204 of FIG. 2, and the display 710 of FIG. 7). The electronic may include at least one processor (e.g., the processor 120 of FIG. 1, the processor of 203 of FIG. 2, and the processor 720 of FIG. 7). The electronic may include memory (e.g., the memory 130 of FIG. 1, the memory 207 of FIG. 2, and the memory 730 of FIG. 7) for storing instructions. The instructions, when executed by the at least one processor individually or collectively, may cause the electronic device to receive an utterance of a user. The instructions, when executed by the at least one processor individually or collectively, may cause the electronic device to obtain information on UI components displayed on the display, based on context information of the electronic device. The instructions, when executed by the at least one processor individually or collectively, may cause the electronic device to map weights to the UI components based on the information on the UI components and gaze information of the user. The instructions, when executed by the at least one processor individually or collectively, may cause the electronic device to determine a UI component for which a state is to be updated by the utterance among the UI components, based on a weight mapping result and the utterance. The instructions, when executed by the at least one processor individually or collectively, may cause the electronic device to update the state of the determined UI component based on the utterance.

According to an embodiment, the context information of the electronic device may include information on an application driven in the electronic device at a point in time at which the utterance is received.

According to an embodiment, the information on the UI components may include position information of UI components displayed on the display.

According to an embodiment, the instructions, when executed by the at least one processor individually or collectively, may cause the electronic device to obtain information associated with a trajectory of a gaze or eye of the user from a wearable electronic device (e.g., the wearable electronic device 500 of FIG. 5) connected to the electronic device. The instructions, when executed by the at least one processor individually or collectively, may cause the electronic device to obtain the gaze information based on the information associated with the trajectory of the gaze or eye of the user.

According to an embodiment, the electronic device may be a wearable electronic device (e.g., the wearable electronic device 600 of FIG. 6) implemented in the form of an HMD including an AR device, a VR device, and an MR device.

According to an embodiment, the gaze information may correspond to a result obtained by tracking eyes of a user by the electronic device.

According to an embodiment, the gaze information may correspond to a focus of a user who gazes at an arbitrary point on the display.

According to an embodiment, the weights may be set based on a distance between the focus and a UI component.

According to an embodiment, the weights may be set to be inversely proportional to a distance between the focus and a UI component.

According to an embodiment, the instructions, when executed by the at least one processor individually or collectively, may cause the electronic device to, when the focus corresponds to an arbitrary UI component, map a weight of “0” to a UI component other than the arbitrary UI component.

According to an embodiment, the instructions, when executed by the at least one processor individually or collectively, may cause the electronic device to determine whether to update a state by the utterance, sequentially starting from a UI component to which a highest weight is mapped.

According to an embodiment, the instructions may be triggered when a sustained gaze of a user at one of the UI components is detected.

According to an embodiment, the instructions may be triggered when an utterance including a wake-up word of a voice assistant is received prior to the utterance.

According to an embodiment, the instructions may be triggered when the utterance includes a wake-up word of a voice assistant.

According to an embodiment, the instructions may be triggered when a touch input to the display is received.

An electronic device (e.g., the electronic device 101 of FIG. 1, the electronic device 201 of FIG. 2, and the electronic device 701 of FIG. 7) according to an embodiment may include a display (e.g., the display module 160 of FIG. 1, the display module of 204 of FIG. 2, and the display 710 of FIG. 7). The electronic may include at least one processor (e.g., the processor 120 of FIG. 1, the processor of 203 of FIG. 2, and the processor 720 of FIG. 7). The electronic may include memory (e.g., the memory 130 of FIG. 1, the memory 207 of FIG. 2, and the memory 730 of FIG. 7) for storing instructions. The instructions, when executed by the at least one processor individually or collectively, may cause the electronic device to track a gaze of a user at the display. The instructions, when executed by the at least one processor individually or collectively, may cause the electronic device to receive an utterance of the user. The instructions, when executed by the at least one processor individually or collectively, may cause the electronic device to update a state of a UI component displayed on the display, based on the utterance.

According to an embodiment, the instructions, when executed by the at least one processor individually or collectively, may cause the electronic device to obtain information on UI components displayed on the display, based on context information of the electronic device. The instructions, when executed by the at least one processor individually or collectively, may cause the electronic device to map weights to the UI components based on the information on the UI components and gaze information of the user. The instructions, when executed by the at least one processor individually or collectively, may cause the electronic device to determine a UI component for which a state is to be updated by the utterance among the UI components, based on a weight mapping result and the utterance. The instructions, when executed by the at least one processor individually or collectively, may cause the electronic device to update the state of the determined UI component based on the utterance.

According to an embodiment, the instructions, when executed by the at least one processor individually or collectively, may cause the electronic device to obtain information associated with a trajectory of a gaze or eye of the user from a wearable electronic device (e.g., the wearable electronic device 500 of FIG. 5) connected to the electronic device. The instructions, when executed by the at least one processor individually or collectively, may cause the electronic device to obtain gaze information of the user in real time based on the information associated with the trajectory of the gaze or eye of the user.

According to an embodiment, the electronic device may be a wearable electronic device (e.g., the wearable electronic device 600 of FIG. 6) implemented in the form of an HMD including an AR device, a VR device, and an MR device. The instructions, when executed by the at least one processor individually or collectively, may cause the electronic device to obtain gaze information of the user in real time.

According to an embodiment, the updating of the state of the UI component may be triggered when the utterance includes a wake-up word of a voice assistant.

According to an embodiment, the gaze information may correspond to a focus of a user who gazes at an arbitrary point on the display.

The electronic device according to various embodiments may be one of various types of electronic devices. The electronic device may include, for example, a portable communication device (e.g., a smartphone), a computer device, a portable multimedia device, a portable medical device, a camera, a wearable device, a home appliance device, or the like. According to an embodiment of the disclosure, the electronic device is not limited to those mentioned above.

It should be appreciated that various embodiments of the disclosure and the terms used therein are not intended to limit the technological features set forth herein to particular embodiments and include various changes, equivalents, or replacements for a corresponding embodiment. In connection with the description of the drawings, like reference numerals may be used for similar or related components. It is to be understood that a singular form of a noun corresponding to an item may include one or more of the things, unless the relevant context clearly indicates otherwise. As used herein, “A or B,” “at least one of A and B,” “at least one of A or B,” “A, B or C,” “at least one of A, B and C,” and “at least one of A, B, or C,” may include any one of the items listed together in the corresponding one of the phrases, or all possible combinations thereof. Terms such as “1st” and “2nd,” or “first” and “second” may be used to simply distinguish a corresponding component from other components, and do not limit the components in other aspects (e.g., importance or order). It is to be understood that if a component (e.g., a first component) is referred to, with or without the term “operatively” or “communicatively,” as “coupled with,” “coupled to,” “connected with,” or “connected to” another component (e.g., a second component), the component may be coupled with the other component directly (e.g., by wire), wirelessly, or via a third component.

As used in connection with various embodiments of the disclosure, the term “module” may include a unit implemented in hardware, software, or firmware, or a combination thereof, and may interchangeably be used with other terms, for example, “logic,” “logic block,” “part,” or “circuitry.” A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program) including one or more instructions that are stored in a storage medium (e.g., the internal memory or the external memory) that is readable by a machine (e.g., the electronic device). For example, a processor of the machine (e.g., the electronic device) may invoke at least one of the one or more instructions stored in the storage medium, and execute it. This allows the machine to be operated to perform at least one function according to the at least one instruction invoked. The one or more instructions may include code generated by a compiler or code executable by an interpreter. The machine-readable storage medium may be provided in the form of a non-transitory storage medium. Here, the term “non-transitory” simply means that the storage medium is a tangible device, and does not include a signal (e.g., an electromagnetic wave), but this term does not differentiate between data being semi-permanently stored in the storage medium and the data being temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., a compact disc read-only memory (CD-ROM)), or be distributed (e.g., downloaded or uploaded) online via an application store (e.g., PlayStore™), or between two user devices (e.g., smartphones) directly. If distributed online, at least part of the computer program product may be temporarily generated or at least temporarily stored in the machine-readable storage medium, such as a memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components or operations may be omitted, or one or more other components or operations may be added. Alternatively or additionally, a plurality of components (e.g., modules or programs) may be integrated into a single component. In such a case, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

While the disclosure has been illustrated and described with reference to various example embodiments, it will be understood that the various example embodiments are intended to be illustrative, not limiting. It will be further understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

What is claimed is:

1. An electronic device comprising:
a display;
at least one processor; and
memory for storing instructions that, when executed by the at least one processor individually or collectively, cause the electronic device to:
receive an utterance of a user;
obtain information on user interface (UI) components displayed on the display, based on context information of the electronic device;
map weights to the UI components based on the information on the UI components and gaze information of the user;
determine a UI component for which a state is to be updated by the utterance among the UI components, based on a weight mapping result and the utterance; and
update the state of the determined UI component based on the utterance.

2. The electronic device of claim 1, wherein the context information of the electronic device comprises information on an application driven in the electronic device at a point in time at which the utterance is received.

3. The electronic device of claim 1, wherein the information on the UI components comprises position information of UI components displayed on the display.

4. The electronic device of claim 1, wherein the instructions, when executed by the at least one processor individually or collectively, cause the electronic device to:
obtain information associated with a trajectory of a gaze or eye of the user from a wearable electronic device connected to the electronic device; and
obtain the gaze information based on the information associated with the trajectory of the gaze or eye of the user.

5. The electronic device of claim 1, wherein
the electronic device is a head mounted display (HMD) comprising an augmented reality (AR) device, a virtual reality (VR) device, and a mixed reality (MR) device, and
the gaze information corresponds to a result obtained by tracking eyes of the user by the electronic device.

6. The electronic device of claim 1, wherein the gaze information corresponds to a focus of a user who gazes at an arbitrary point on the display.

7. The electronic device of claim 6, wherein the weights are set based on a distance between the focus and a UI component.

8. The electronic device of claim 6, wherein the weights are set to be inversely proportional to a distance between the focus and a UI component.

9. The electronic device of claim 6, wherein the instructions, when executed by the processor individually or collectively, cause the electronic device to:
when the focus corresponds to an arbitrary UI component, map a weight of “0” to a UI component other than the arbitrary UI component.

10. The electronic device of claim 1, wherein the instructions, when executed by the processor individually or collectively, cause the electronic device to:
determine whether to update a state by the utterance, sequentially starting from a UI component to which a highest weight is mapped.

11. The electronic device of claim 1, wherein the instructions are triggered when a sustained gaze of the user at one of the UI components is detected.

12. The electronic device of claim 1, wherein the instructions are triggered when an utterance comprising a wake-up word of a voice assistant is received prior to the utterance.

13. The electronic device of claim 1, wherein the instructions are triggered when the utterance comprises a wake-up word of a voice assistant.

14. The electronic device of claim 1, wherein the instructions are triggered when a touch input to the display is received.

15. An electronic device comprising:
a display;
at least one processor; and
memory for storing instructions that, when executed by the at least one processor individually or collectively, cause the electronic device to:
track a gaze of a user at the display;
receive an utterance of the user; and
update a state of a user interface (UI) component displayed on the display, based on the utterance,
wherein the UI component is a UI component corresponding to the user's gaze before a point in time at which the utterance is received.

16. The electronic device of claim 15, wherein the instructions, when executed by the processor individually or collectively, cause the electronic device to:
obtain information on UI components displayed on the display, based on context information of the electronic device;
map weights to the UI components based on the information on the UI components and gaze information of the user;
determine a UI component for which a state is to be updated by the utterance among the UI components, based on a weight mapping result and the utterance; and
update the state of the determined UI component based on the utterance.

17. The electronic device of claim 15, wherein the instructions, when executed by the processor individually or collectively, cause the electronic device to:
obtain information associated with a trajectory of a gaze or eye of the user from a wearable electronic device connected to the electronic device; and
obtain gaze information of the user in real time based on the information associated with the trajectory of the gaze or eye of the user.

18. The electronic device of claim 15, wherein
the electronic device is a head mounted display (HMD) comprising an augmented reality (AR) device, a virtual reality (VR) device, and a mixed reality (MR) device, and
the instructions, when executed by the processor, individually or collectively, cause the electronic device to obtain gaze information of the user in real time.

19. The electronic device of claim 15, wherein updating of the state of the UI component is triggered when the utterance comprises a wake-up word of a voice assistant.

20. The electronic device of claim 16, wherein the gaze information corresponds to a focus of a user who gazes at an arbitrary point on the display.
